(19) United States
(12) Patent Application Publication
(10) Pub. No.: US 2002/0005330 A1
(43) Pub. Date: Jan. 17, 2002

(54) Escalator step

(76) Inventors: Gerhard Lunardi, Wien (AT); Reinhard Pallinger, Wien (AT)

Correspondence Address: SCHWEITZER CORNMAN GROSS & BONDELL LLP, 292 MADISON AVENUE - 19th FLOOR, NEW YORK, NY, 10017, US

(21) Appl. No.: 09/727,254

(22) Filed: Nov. 30, 2000

(30) Foreign Application Priority Data
Dec. 2, 1999 (EP) 99 811109.0

(51) Int. Cl. B66B 23/12

(52) U.S. Cl. 198/333

(57) ABSTRACT

This escalator step, which may be formed of a fiber-reinforced synthetic material, has an improved rigidity and reduced bending stress when loaded. The escalator step is provided with at least one support mount which mechanically positively connects with a connecting axle for the escalator step chains.

### BACKGROUND OF THE INVENTION

There has been made known by PCT patent application WO 95/23758 an escalator step which is made of an injection molded fiber-reinforced thermoplastic synthetic material. With such an escalator step, unacceptable bending stresses can occur when loaded, notwithstanding reinforcings by stiffening ribs. In order to avoid such stresses, the aforesaid application proposes the use of a so-called reinforcing arch situated under the tread part of the escalator step, which arch extends over approximately the entire width of the tread part and rests at a central region on a connecting axle mounted on the step chains of the escalator. In this manner, the loads leading to unacceptable bending stresses of the escalator step are intended to be transferred directly to the connecting axle and thus the bending stresses avoided. Such an escalator step is of relatively complicated construction and requires, for its production, a complicated tool and a costly production process, whereby manufacturing costs are made more expensive. Moreover, vibrations, which can lead to undesired noises, can result from the play that arises with ageing of the step or tolerances in its manufacture.

### BRIEF DESCRIPTION OF THE INVENTION

The present invention has an object of the forming of an escalator step of the general foregoing kind, which has improved running properties with a high load-bearing capability and which can be produced simply and economically in large batches.

This object is met by an escalator step having receiving openings for the mounting of a connecting axle in which at least one additional support mount by means of which the escalator step is mechanically positively connected with the connecting axle is provided at the escalator step in a region between the receiving openings.

The support mounts may take various forms, and can have mounting bores or mounting openings for reception of the connecting axle.

The inventive nature of the escalator step lies in a constructional modification of the escalator or moving walkway step in such a manner that sufficient load-bearing capability of the step can be produced by the resulting novel design suitable for manufacture without the overall weight of the step being increased. Instead of more costly reinforcing ribs and thicker walls, the invention provides for one or more discrete support mounts which are supported on the connecting axle in the region between the mounting locations for the connecting axle in the step side walls.

The advantages achieved by the invention are to be seen in that the connecting axle in conjunction with the connecting axle mounts and the support mounts according to the invention can be utilized for reduction in bowing. In distinction from prior art escalator steps in which the tread surface when loaded is, as a consequence of bowing, supported on the connecting axle by way of the reinforcing arch, the local additional support according to the invention reduces bowing without further measures such as ribbing, supplementary profiles or the like. In the case of several additional support mounts appropriately distributed over the step width, which correspond in their function to the connecting axle mounts, the step is fixed on the connecting axle by way of these points.

In such a case, the connecting axle represents a stabilizing element, and shape-locking additional support mount or mounts, the riser part, the tread part and the side parts represent in combination a three-dimensionally stiff step box construction or frame construction. This larger bending resistance moment of the escalator step makes it additionally possible to be able to largely dispense with ribbing and to produce thinner wall thicknesses.

The manufacture of escalator steps according to the invention is possible with simple die-casting molds and tools, with a saving in raw materials. In the case of, in particular, escalator steps or moving walkway plates made in larger batches, this has an advantageous effect on overall costs.

Vibrations and the disturbing creation of noise associated therewith are avoided by the mechanically positive connection of the additional support mounts with the connecting axle.

### BRIEF DESCRIPTION OF THE DRAWINGS

A preferred, but nonetheless illustrative, embodiment of the invention is more fully explained in the following detailed description thereof, in conjunction with the annexed drawing, in which:

FIG. 1 is an elevation view of an elevator step according to the invention;

FIG. 2 is a side view of the escalator step seen from the direction A in FIG. 1;

FIG. 3 is a rear view of the escalator step mounted on step chains, seen from direction B in FIG. 4;

FIG. 4 is a side view of the escalator step mounted on step chains, seen from the direction C in FIG. 3; and

FIG. 5 is a detail view, in enlarged representation, of a region D of the escalator step mounted on step chains according to FIG. 3.

### DETAILED DESCRIPTION OF THE INVENTION

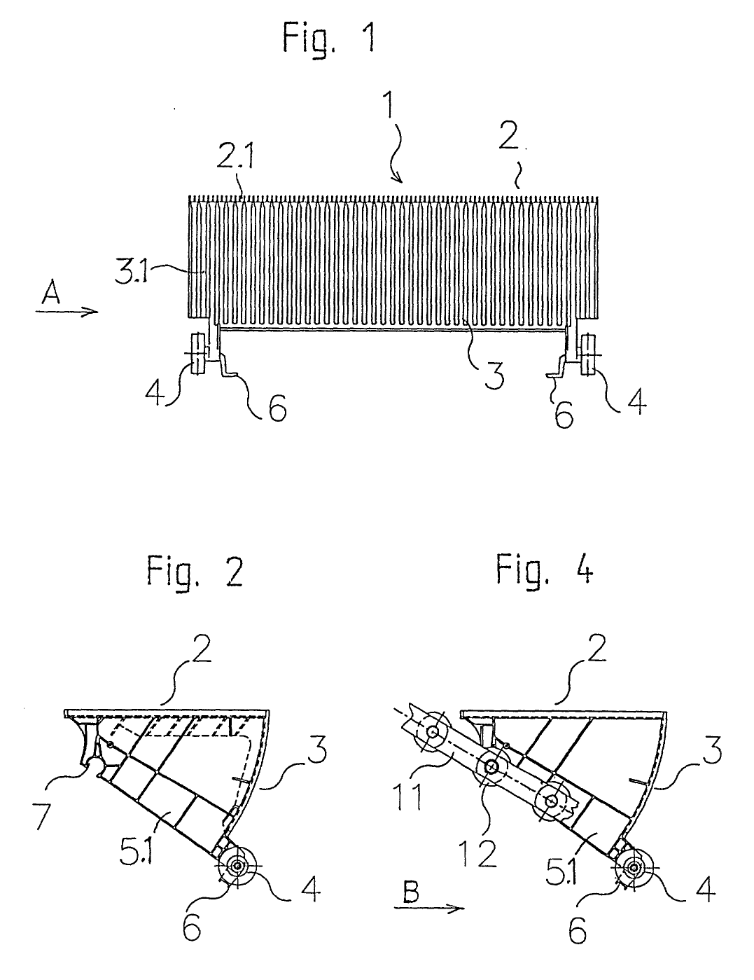

An escalator step which consists of a tread part 2, a riser part 3 and two side walls 5.1 and 5.2 is denoted by 1 in FIGS. 1 to 5. The step part 2 and the riser part 3 have, as known, surface grooves 2.1 and 3.1 extending in the direction of travel. A respective drag roller 4 and a respective jaw 6 are situated at each of the side walls 5.1 and 5.2 at the lower end of the riser part 3. The side walls 5.1 and 5.2 further have receiving openings 7 for the mounting of the escalator step on a connecting axle 8. The mounting can be effected by way of bearing bushings 9, which are secured on the connecting axle 8 against sliding by means of clamping elements 10. The connecting axle 8 is mounted by way of axle extensions 8.1 to step chains 11 which extend at both sides of the escalator step 1. The step chains 11 include chain rollers 12 mounted by way of ball bearings 13 thereto.

Support mounts 14, by way of which the escalator step 1 is connected in a shape-maintaining manner with the connecting axle 8, are provided at the escalator step 1 below the step part 2 and between the side walls 5.1 and 5.2. When loaded, the escalator step 1 is supported by way of the support mounts 14 on the connecting axle 8, wherein the bending stress in the rearward region of the step part 2 is greatly reduced. The rigidity of the escalator step 1, which consists of die cast metal, synthetic material or several permanently connected elements, but preferably consists of fiber-reinforced synthetic material, is accordingly improved. The support mounts 14 have mounting bores in which the bearing bushings 9 are inserted for the reception of the connecting axle 8 and are secured by means of the clamping elements 10. Instead of the mounting bores, mounting openings 15, which are similar to the above-described receiving openings 7 and in which bearing bushes 9 are similarly inserted and secured by means of clamping elements 10, can also be provided in the support mounts 14. The mounting openings 15 are formed to be semicircular, the side wall thereof forming an open jawed or fork-like construction, wherein the angle of opening is smaller than 180 degrees.

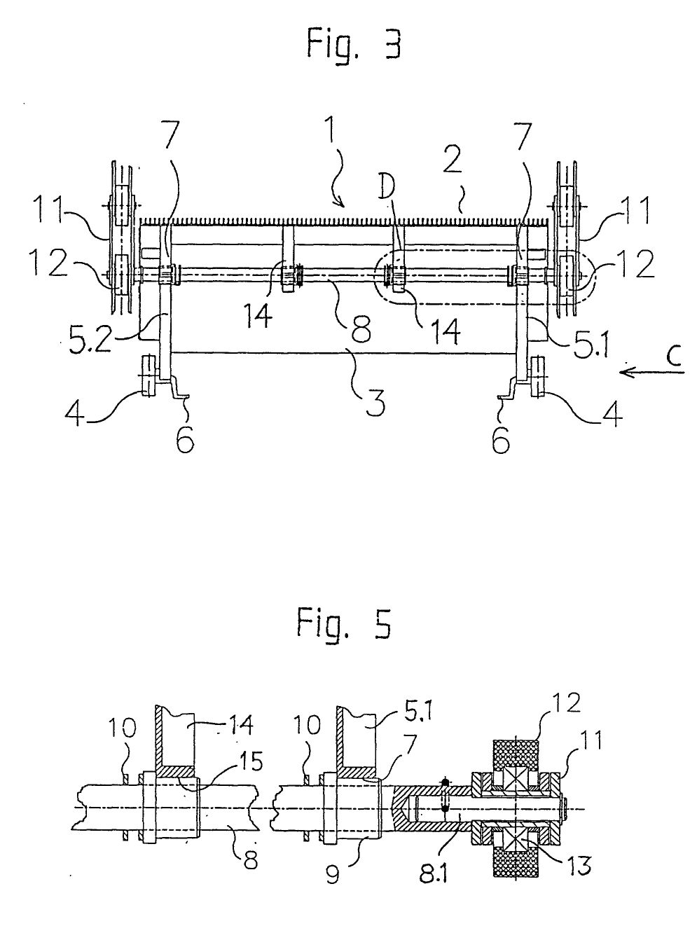

It is within the scope of the invention to provide more than the two support mounts 14 illustrated in FIG. 3 or even only one support mount 14. Moreover, it is possible to realize the connections of the support mounts 14 with the connecting axle 8 without bearing bushings 9. Further, it is within the scope of the invention that the design of the mechanically positive connection can differ from the illustrated embodiment. It is also self-evident that the proposed inventive measures for improvement of the rigidity of the escalator step can also be used with moving walkway plates. The invention can be used not only with escalator steps or moving walkway plates made from one piece, but also with such which are assembled from several parts and/or consist of other materials.

We Claim:

1. An escalator step having receiving openings for mounting on a continuous connecting axle for step chains, comprising at least one discrete additional support mount for positively connecting the escalator step to the connecting axle located in a region between the receiving openings of the escalator step.

2. An escalator step according to claim 1, wherein the support mount has mounting means in the form of a mounting bore for the reception of the connecting axle.

3. An escalator step according to claim 1, wherein the support mount has mounting means in the form of a semicircular mounting opening for the reception of the connecting axle, the mounting opening being in an open manner and the angle of opening is smaller than 180 degrees.

4. An escalator step according to claim 2 further comprising a bearing bushing for the reception of the connecting axle located in the mounting means.
